(19) United States
(12) Patent Application Publication
(10) Pub. No.: US 2013/0238999 A1
(43) Pub. Date: Sep. 12, 2013

(54) SYSTEM AND METHOD FOR MUSIC COLLABORATION

(71) Applicant: APPLE INC., Cupertino, CA (US)

(72) Inventors: Jan-Hinnerk Helms, Rellinger (DE); Tobias Manuel Hermann, Hamburg (DE); Vincent Peter Reuter, Hamburg (DE); Carsten Schulz, Hamburg (DE); John Danty, San Jose, CA (US); Alexander Soren, San Francisco, CA (US)

(73) Assignee: Apple Inc., Cupertino, CA (US)

(21) Appl. No.: 13/787,706

(22) Filed: Mar. 6, 2013

Related U.S. Application Data
(60) Provisional application No. 61/607,577, filed on Mar. 6, 2012.

(51) Int. Cl. G06F 3/16

(52) U.S. Cl. CPC G06F 3/165
USPC 715/727

(57) ABSTRACT

Techniques are provided for enabling a collaborative music session between multiple participants. In certain embodiments, a user may create a jam session using his/her electronic device. One or more other participants may then join the jam session using their electronic devices. The jam session participants may then jam together using their electronic devices as virtual music instruments. A musical memento of the jam session can then be stored for subsequent playback.

### CROSS-REFERENCES TO RELATED APPLICATIONS

The present non-provisional application claims benefit under 35 U.S.C. §119 of U.S. Provisional Patent Application No. 61/607,577, filed on Mar. 6, 2012, and entitled “SYSTEM AND METHOD FOR MUSIC COLLABORATION” which is herein incorporated by reference in its entirety for all purposes.

### BACKGROUND

The disclosed embodiments relate generally to music-related processing, and more particularly to techniques that enable a group of users to create and participate in a collaborative music session.

Advances in recording devices and virtual instruments have allowed users to more easily create, record, and edit music in the digital realm. The proliferation of computers in various forms has made both the creation and playback of music recordings accessible to users, including musicians and non-musicians alike, without the need for music studios, expensive equipment, and the like. The rising popularity of mobile devices, such as portable laptops, smartphones, which can function as virtual musical instruments, has enabled users to make music in an easy manner.

### BRIEF DESCRIPTION OF THE DRAWINGS

FIG. 1A is a simplified flow diagram illustrating aspects of a method of creating a jam session between electronic devices, according to embodiments of the invention.

FIG. 1B is a simplified flow diagram illustrating aspects of a method of creating a jam session between electronic devices, according to embodiments of the invention.

FIG. 1C is a simplified flow diagram illustrating aspects of a method of creating a jam session between electronic devices, according to embodiments of the invention.

FIG. 2 is a simplified flow diagram illustrating aspects of a method of initiating song architecture changes during a jam session, according to an embodiment of the invention.

FIG. 3 is a simplified flow diagram illustrating aspects of a method of initiating song architecture changes offline, according to an embodiment of the invention.

FIG. 4 is a simplified flow diagram illustrating aspects of a method of accessing user songs during a jam session, according to an embodiment of the invention.

FIG. 5A is a simplified flow diagram illustrating aspects of a method of leaving a jam session, according to an embodiment of the invention.

FIG. 5B is a simplified flow diagram illustrating aspects of a method of leaving a jam session, according to an embodiment of the invention.

FIG. 6A is a simplified flow diagram illustrating aspects of a method of collecting recordings in a jam session

FIG. 6B is a simplified flow diagram illustrating aspects of a method of collecting recordings in a jam session

FIG. 6C is a simplified flow diagram illustrating aspects of a method of collecting recordings in a jam session.

FIG. 6D is a simplified flow diagram illustrating aspects of a method of collecting recordings in a jam session.

FIG. 7 illustrates an embodiment of a Jam Session interface, according to an embodiment of the invention.

FIG. 8 illustrates an embodiment of a Jam Session interface once a jam session is created, according to an embodiment of the invention.

FIG. 9 is simplified flow diagram illustrating aspects of a method to determine a round-trip measurement from a client device to a host device in a jam session, according to an embodiment of the invention.

FIG. 10 illustrates an example of a device that can enable a user to establish a jam session between multiple remote computing devices to create and record music in real time, according to an embodiment of the invention.

FIG. 11 illustrates a computer system according to an embodiment of the present invention.

FIG. 12 is a simplified flow diagram illustrating aspects of creating and ending a jam session, according to an embodiment of the invention.

FIG. 13 is a simplified block diagram illustrating aspects of a musical performance system provided on a server that is communicatively coupled with a remote client device via a network.

### DETAILED DESCRIPTION

In the following description, for the purposes of explanation, specific details are set forth in order to provide a thorough understanding of embodiments of the invention. However, it will be apparent that various embodiments may be practiced without these specific details.

Certain embodiments of the invention allow two or more users to form a band, jam together and save a musical memento of the jam session. Two or more computing devices (e.g., tablet computers, laptops, desktops, etc.) operating music creation and recording software can be communicatively coupled together (e.g., wirelessly, hardwired, etc.) to provide a synchronized real-time jamming experience. Each jam session can have a band leader, who may be the user operating a host device that creates the jam session, and one or more band members, who may operate client devices to join the jam session. Tasks performed by the band leader may include creating a jam session, selecting one or more songs for the jam session, operating playback and recording controls (e.g., playback, record, rewind, fast forward functions, and the like), verifying song architecture uniformity (e.g., tempo, time signature, key signature, etc.) and collecting the recordings from the devices involved in the jam session after the session is complete. In some embodiments, if a jam session is interrupted (e.g., school break is over, network failure, etc.), the participants can pick up the session and continue where they left off. Once the band members of the jam session are satisfied with the result, the band leader (i.e., host) can either manually or automatically collect the recordings of each band member via the communicative coupling means (e.g., wireless coupling) and archive a complete recording of the session for subsequent playback, editing, or further jam sessions (i.e., “sessioning”).

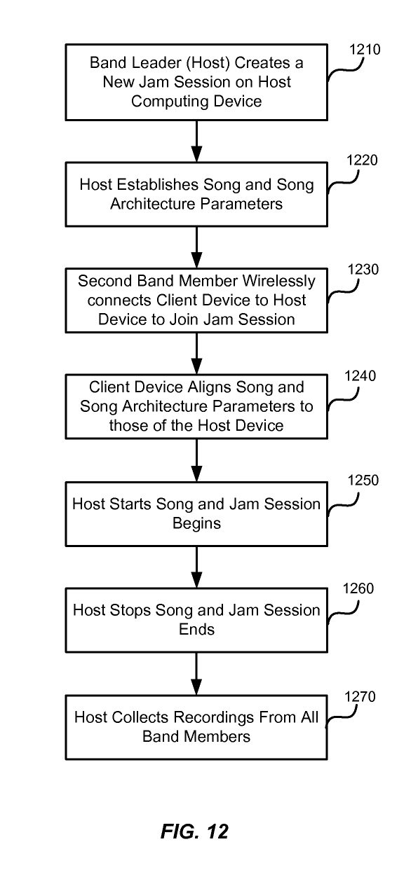

FIG. 12 is a simplified flow diagram illustrating aspects of creating and ending a jam session, according to an embodiment of the invention. At 1210, the band leader (i.e., host) creates a new jam session on a host device (e.g., tablet computer). At 1220, the host can establish and/or select a song to play and determine the song architecture characteristics (e.g., tempo, key signature, etc.) that define the song. At 1230, a client device from a second band member communicatively connects to the host device to join the jam session. In other words, the host device adds the client device to the host session, where the host device that is operating the host session is configured to control recording and playback operations of the host song and any aligned client songs operating on one or more connected client devices. The client device(s) can connect wirelessly (e.g., Bluetooth, infra-red, etc.), hard-wire connection, or otherwise. At 1240, the client device selects the song established by the host device and aligns (i.e., synchronizes) the song architecture parameters to those of the host device. At 1250, the host device begins the song and the jam session begins. The host device can control playback, recording, etc., for each device in the jam session. At 1260, the host device stops the song and may end the jam session. The host device can also end the song and change parameters without ending the jam session. For example, the host can start a new song, change parameters in an existing song, restart a previous song, and the like, as further described in more detail below. At 1270, the host device collects recordings from the client device(s) in the jam session. The host can then edit, mix, master, and manipulate each recording as desired.

System Architecture

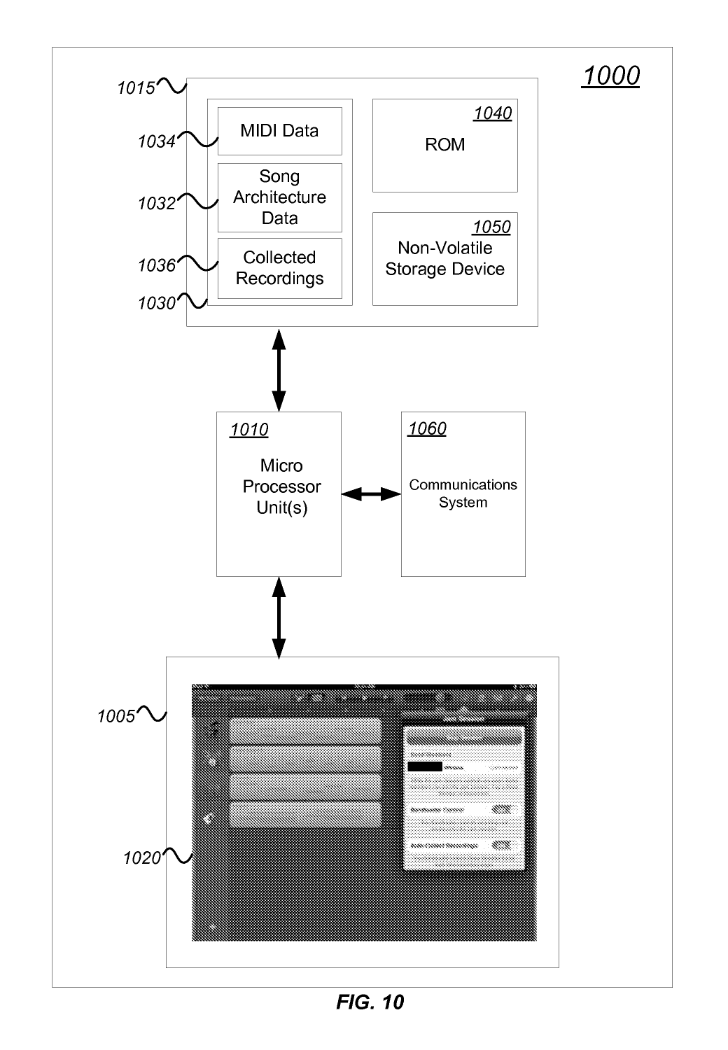

FIG. 10 illustrates an example of a musical performance system 1000 that can enable a user to establish a jam session between multiple remote computing devices to create and record music in real time, according to an embodiment of the invention. Musical performance system 1000 can be a device that can include multiple subsystems such as a display subsystem 1005, one or more processors or processing units 1010, a storage subsystem 1015, and a communications system 1060. One or more communication paths can be provided to enable one or more of the subsystems to communicate with and exchange data with one another. The various subsystems in FIG. 10 can be implemented in software, hardware, firmware, or combinations thereof. In some embodiments, the software can be stored on a transitory or non-transitory computer readable storage medium and can be executed by one or more processing units. In certain embodiments, storage subsystem 1015 comprises one or more memories for storing the data used or generated by certain embodiments of the present invention and for storing software (e.g., code, computer instructions) that may be executed by one or more processing units 1010.

It should be appreciated that musical performance system 1000 as shown in FIG. 10 can include more or fewer components than those shown in FIG. 10, can combine two or more components, or can have a different configuration or arrangement of components. In some embodiments, musical performance system 1000 can be a part of a portable computing device, such as a tablet computer, a mobile telephone, a smart phone, a desktop computer, a laptop computer, a kiosk, etc. The musical performance system 1000 can operate on an iPhone, iPad, iMac, or the like.

In some embodiments, display subsystem 1005 can provide an interface that allows a user to interact with musical performance system 1000. The display subsystem 1005 may be a cathode ray tube (CRT), a flat-panel device such as a liquid crystal display (LCD), a projection device, a touch screen, and the like. In general, use of the term “output device” is intended to include all possible types of devices and mechanisms for outputting information from computer system 1400. For example, a software keyboard may be displayed using a flat-panel screen. In some embodiments, the display subsystem 1005 can be a touch interface, where the display provides both an interface for outputting information to a user of the device and also as an interface for receiving inputs. In other embodiments, there may be separate input and output subsystems. Through the display subsystem 1005, the user can view and interact with a GUI (Graphical User Interface) 1020 of a musical performance system 1000. In some embodiments, display subsystem 1005 can include a touch-sensitive interface (also sometimes referred to as a touch screen) that can both display information to the user and receive inputs from the user. Processing unit(s) 1010 can include one or more processors that each have one or more cores. In some embodiments, processing unit(s) 1010 can execute instructions stored in storage subsystem 1015.

Communications system 1060 can include various hardware, firmware, and software components to enable electronic communication between multiple computing devices. Communications system 1060 or components thereof can communicate with other devices via Wi-Fi, Bluetooth, infra-red, or any other suitable communications protocol that can provide sufficiently fast and reliable data rates to support the real-time jam session functionality described herein.

Storage subsystem 1015 can include various memory units such as a system memory 1030, a read-only memory (ROM) 1040, and a non-volatile storage device 1050. The system memory can be a read-and-write memory device or a volatile read-and-write memory, such as dynamic random access memory. System memory 1030 can store some or all of the instructions and data that the processor(s) or processing unit(s) need at runtime. ROM 1040 can store static data and instructions that are used by processing unit(s) 1010 and other modules of system 1000. Non-volatile storage device 1050 can be a read-and-write capable memory device. Embodiments of the invention can use a mass-storage device (such as a magnetic or optical disk or flash memory) as a permanent storage device. Other embodiments can use a removable storage device (e.g., a floppy disk, a flash drive) as a non-volatile (e.g., permanent) storage device.

Storage subsystem 1015 can store MIDI (Musical Instrument Digital Interface) data 1034 relating to music played on virtual instruments of the musical performance system 1000, song architecture data 1032 to store song architecture parameters (which may be a subset of general song data) for each jam session, and collected recordings 1036 for storing collected tracks after each jam session. Storage subsystem 1015 may also store audio recording data, and general song data (e.g., with track and instrument data). For MIDI-based tracks, MIDI data may be stored. Similarly, for audio-based tracks, audio data can be stored (e.g., audio files such as .wav, .mp3, and the like). Further detail regarding system architecture and the auxiliary components thereof (e.g., input/output controllers, memory controllers, etc.) are not discussed in detail so as not to obfuscate the focus on the invention and would be understood by those of ordinary skill in the art.

Jam Session Interface

Certain embodiments described herein can be implemented by any suitable electronic device with music creation and recording capabilities. An example of such an electronic device is a device that is capable of executing a music creation and recording application (referred to herein as a “music application”). An example of such an application is the GarageBand™ application provided by Apple Inc. A variety of different devices including but not limited to tablet computers, smart phones, laptops, PDA's, and the like may provide this functionality.

According to certain embodiments, Jam Session functionality can be provided as a feature by the music application. For example, the GarageBand™ application may provide a user-selectable option (e.g., a UI icon or control button in a control bar of GarageBand™), which when selected by a user, invokes the jam session functionality described herein. When a host establishes a jam session on a host device, the icon can indicate that a jam session is active. For example, the icon can change color, appear illuminated, flash, or perform some other visual cue to alert the host that a jam session is active. In other embodiments, other indicators can be used to provide the user with a visual notification that a Jam Session is in progress. As each new band member (i.e., client and client device) joins the Jam Session, their UI icons can also indicate that they have joined the host's Jam Session. In one embodiment, a client can join a session while a Jam Session pop-up menu is open on the host device. If the pop-up menu is closed, subsequent join requests may be automatically denied.

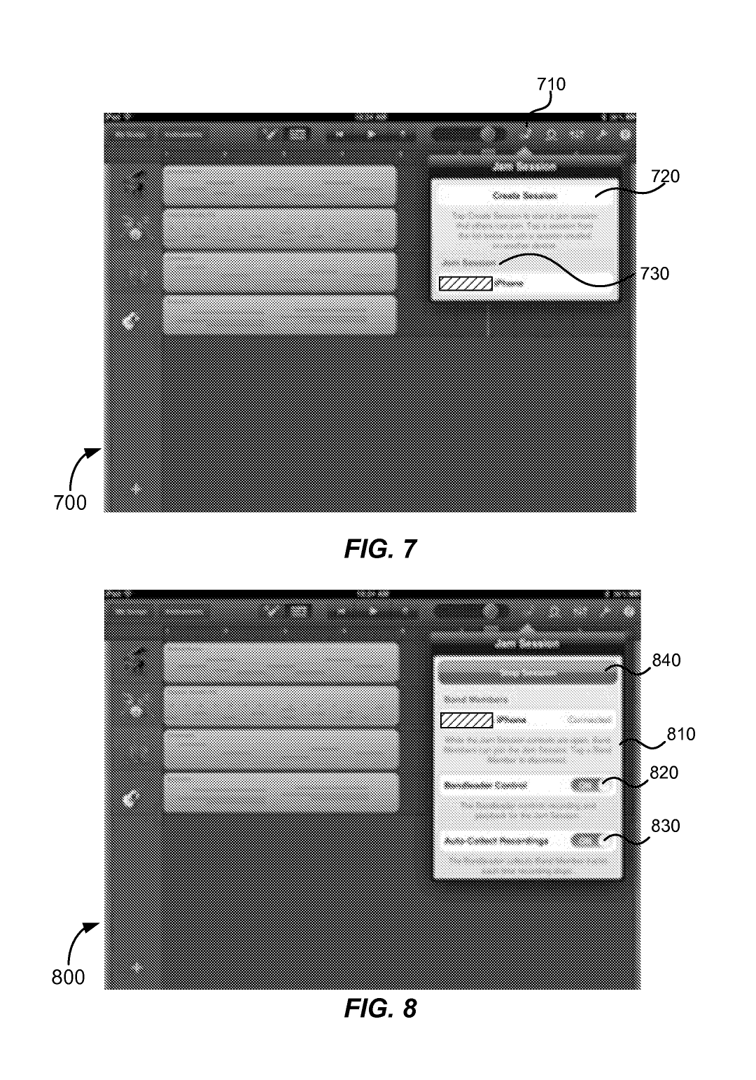

FIG. 7 illustrates an embodiment of a Jam Session interface 700 that may be displayed by a device providing jam session capabilities, according to an embodiment of the invention. The Jam Session interface 700 includes a UI icon 710, which when selected by a user, can cause a jam session pop-up menu comprising a “create session” tool bar 720 and a “join session” tool bar 730 to be displayed. A user can press “create session” 720 to create their own jam session, which may appear on other devices as a session that can be joined. According to certain embodiments, the “join session” 730 tool bar lists currently available jam sessions that have been created on other devices and are available to join. A user can optionally select one of the sessions listed beneath “join session” to join a session created on another device and currently in progress.

A user of a musical performance system 1000 may create a new jam session. As the creator of the jam session, the user may also be referred to as the band leader or host. For a jam session created by the band leader, the band leader can control the permissions and privileges associated with that jam session. For example, in certain embodiments, the band leader can limit the functionalities provided to other participants in that jam session. In some embodiments, the music application may provide a “bandleader control” feature 820 that allows a band leader to set certain permissions for participants in the jam session. For example, the jam session application may provide transport or playback controls including Stop, Play, Record, Fast Forward, Rewind, and the like. A band leader can limit access to the transport controls to himself/herself or may alternatively share the controls between a number of clients participating in a jam session. In one embodiment, if the bandleader control is turned off, all parties to the jam session may have transport control access. In cases where multiple clients initiate transport control commands, the last change may be applied to the jam session. For example, if three band members initiated three different transport controls, the last initiated transport control would apply to the jam session.

In some embodiments, the play head position (i.e., time position in a song) of the device that initiated play or record can be transmitted to all other peer devices to initiate a “Play” command. Peer devices can include all devices in the jam session, particularly when a bandleader-client hierarchical relationship is not established (i.e., when the bandleader control is turned off), such that each device included in a jam session have equal functionality (e.g., each peer can perform bandleader-like functions such as recording, collecting tracks, controlling the transport controls of other peers, etc.). For example, as Play or Record functions are initiated, each peer device can see the same arrange area (and thus song section) as the peer who initiated the Play or Record function. In some cases, if a peer (e.g., host or client) presses Record, the peer's device begins recording while the other peer devices of the current Jam Session are placed in Play mode. As such, with the bandleader control off, any peer can record (e.g., punch-in or punch-out) at any time.

If the bandleader control is turned on, transport control access is limited to the host. In some embodiments, the transport controls are disabled on client devices and may appear “grayed out” or include some other visual cue to indicate that access is presently denied. In this mode, the host can solely and simultaneously operate the transport controls on all devices in the Jam Session. For example, if Play or Record is pressed on the host device, a play head position of the host device is transmitted to all other devices and a Play command is executed. In other words, as Play or Record functions are initiated, all peer devices should see the same arrange area (and thus song section) as the peer who initiated the Play or Record function.

FIG. 8 illustrates an embodiment of a Jam Session interface 800 once a jam session is created, according to an embodiment of the invention. Jam Session interface 800 includes a user interface window 810 including a bandleader control switch 820, an auto-collect recordings switch 830, and a stop session button 840. In some cases, the bandleader control 820 and auto-collect recordings 830 switches are set to “on” in the default condition.

Some of the embodiments described herein incorporate “slide-out” notifications, which may be displayed in response to various Jam Session events (e.g., a client leaves a session). For example, when a client device disconnects from a session, a slide-out notification may be displayed to the host device and/or remaining client devices in the jam session informing them that a client device has left the jam session. In certain cases, a slide-out notification can be displayed such that it is semi-transparent and overleaved upon the window. The semi-transparency of the notification allows a user to read the information conveyed by the notification but also enables the user to see through the notification to the underlying layer (e.g., virtual instrument controls) and also to touch “through” to the controls covered by the notification. For example, the transport controls underneath the slide-out notification can still be touched while the notification is displayed.

Synchronization and Transport Control

To create and maintain a Jam Session between multiple peers, the host and client devices within the Jam Session should be synchronized with one another to ensure that transport control operations are aligned. In certain embodiments, each participating device in the Jam Session establishes a common time base (i.e., absolute time) to synchronize operations. A Transport Control State Machine (TCSM), which is operated by the host device, receives transport control requests from both the host and client devices. Some transport control requests can include play, pause, rewind, fast forward, record, and the like. The TCSM processes the transport control requests and sends all according actions (e.g., play, record, etc.) to all participating devices in the Jam Session. In some embodiments, a command (e.g., play command) from the TCSM first passes through the various layers of the host device operating system (OS), transmits via a wireless network to one or more client devices, then passes thru the various layers of the one or more client devices' OS to finally be executed on the target devices (i.e., the client device executes the play command). In some cases, each of these stages (e.g., network, operating system and execution) can each add a delay to the transport control information. Depending on the devices used and the various operating system operations therein, a total delay time may differ from one device to the next. Thus, short time delays and good synchronization between peer devices can assure that users participating in a Jam Session can experience what would appear for all practical purposes to be synchronized and simultaneous operation between devices.

Time stamping can be used to resolve potential time delay and synchronization aspects discussed above. In some embodiments, the “Transport Control State Machine” attaches a timestamp to a transport control command. In some embodiments, the timestamp can be the host device's absolute time plus an offset that is larger than the longest latency (e.g., network latency plus device latency) that may potentially occur between devices. The timestamp can be a predetermined static value or may be dynamically optimized at runtime. In some cases, if the client/host device knows its associated latencies (e.g., device and/or network latency), these values can be subtracted from the time stamped transport command to more accurately determine when to execute the transport command.

In certain embodiments, each device in a Jam Session can determine device latency by measuring the time between executing a start command on a host device and executing the start command on the client device. From these time values, an average value can be generated from a number of time measurements during the session. In certain embodiments, the time measurements used to determine the latency between devices in a Jam Session can be determined prior to the users (e.g., host and clients) beginning the Jam Session. For example, the first measurement can be generated on the first start of the application, such as during audio engine initialization due to restart, audio route change, background to foreground selection, and the like. In other words, the inherent latency in a Jam Session can be determined very quickly such that the duration of the latency determination process can be practically imperceptible from a user's perspective. Latency can be determined in any number of ways that would be appreciated by one of ordinary skill in the art with the benefit of this disclosure.

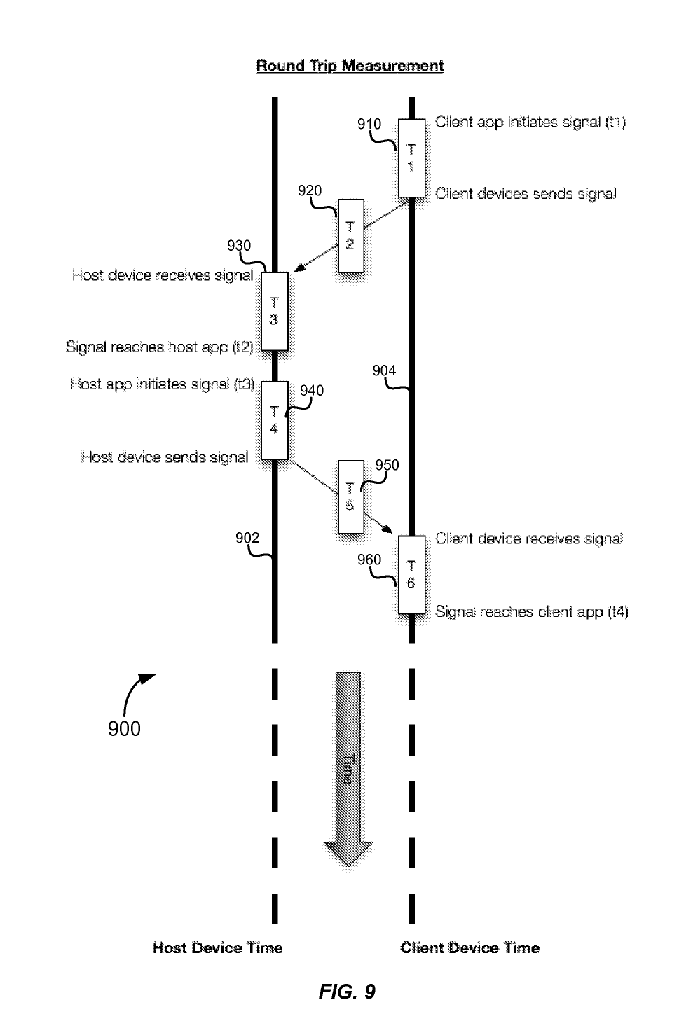

FIG. 9 is simplified flow diagram illustrating aspects of a method 900 for determining a round-trip measurement from a client device to a host device in a jam session, according to an embodiment of the invention. The round trip measurement described herein can determine potential time deviation between host and client devices due to differing clock speeds. In a client device or a host device, the method 900 may be performed by processing logic that may comprise hardware (e.g., circuitry, dedicate logic, etc.), software (which as is run on a general purpose computing system or a dedicated machine), firmware (embedded software), or any combination thereof. In one embodiment, the method 900 can be performed by one or more processor(s) 1010 of FIG. 10.

Referring to FIG. 9, the “round-trip” includes the time it take a client application (e.g., GarageBand™ operating Jam Session functionality) on a client device to send a signal to the host device (or vice versa) and receive a response signal back from the host device. FIG. 9 depicts a time continuum for the client device (“client device time 904”) and the host device (“host device time 902”). Processing is initiated on the client side during time duration T1 (910) where the client Jam Session application initiates a first signal (time “t1”) and sends it to the host device. The first signal can include a timestamp indicating when the client application initiated the first signal (time “t1”). During time duration T2 (920), the first signal is wirelessly coupled (e.g., via Bluetooth technology) from the client device to the host device. During time duration T3 (930), the host device receives the first signal (time “t2”) and routes it to the host application (e.g., GarageBand™ operating Jam Session functionality). The host application tracks the host time that the first signal was received (i.e., the end of time duration T3) and associates that time with the first signal. During time duration T4 (940), the host application initiates a second signal (time “t3”) and sends it to the client application. The second signal can include a timestamp indicating when the host application initiated the second signal (time “t3”). During time duration T5 (950), the second signal can be wirelessly coupled (e.g., via Bluetooth technology) from the host device to the client device. During time duration T6, the client device receives the second signal (t3) and routes it to the client application. The client application determines when the second signal was received and associates it (e.g., encodes the receive time) with the second signal. The client application receives the second signal at time “t4.” By using the timestamps t1-t4, the client device can determine the delay associated with the “roundtrip” and account for that delay when synchronizing all of the devices in the Jam Session.

Round trip calculations can be performed using single round trip signals, or burst signals including a number of round trip signals. In some embodiments, the quality or reliability of the latency measurements are judged by their roundtrip time. For example, calculations to determine latency may consider that the shorter the round trip time, the smaller the error associated in the round trip measurements. In such cases, smaller latency times are weighed heavier than higher latency times in latency calculations, particularly in burst signal measurements. In other words, some embodiments may employ a weighted average to determine latency with more weight given to the shorter measurements. Latencies can be determined a variety of ways including the methods discussed herein, various permutations of those methods, and any other suitable method known by those skilled in the art that can synchronize the operation of peer devices in a jam session.

### Song Architecture Parameters

According to certain embodiments, each song created during a Jam Session includes a number of song architecture parameters. The Jam Session software checks certain song architectural parameters to determine if the songs in each peer device are similar enough to be combined (e.g., during track collection) and/or used together in a Jam Session. In some embodiments, these parameters are aligned across all devices participating in the Jam Session to ensure that the host song is aligned with each client song.

Song architecture parameters can include song section data, time signature data, tempo data, key signature data, custom chord data, master effects preset selection data, count-in data, and fadeout data. The song architecture parameters can be divided into primary and secondary parameters. The primary parameters can include song section data and time signature data. The secondary parameters may include tempo data, key signature data, custom chord data, master effects preset selection data, count-in data, and fade out data.

In some embodiments where Song Sections and/or Time Signature (i.e., primary parameters) differ between a host song on a host device and a client song on a client device, a new empty song may be created on the client device, and the time signature and song section values of the new song are adapted (e.g., automatically) to match the values of the host song parameters. The other secondary parameters of the client song may also be matched to the values of the host song parameters. In some embodiments where both Song Sections and Time Signature are the same on the client and host devices, but the other song architecture parameter values differ, the client may continue with the current song, but the secondary parameter values are matched to those of the host song. In some embodiments where all song architecture parameter values are the same on the client and the host device, the client may continue with the current client song without any changes. It should be noted that matching song architecture parameters between host and client devices as described can ensure that in case of an unintentional Jam Session shutdown (e.g., network failure, etc.), Jam Session peers can pick up the Jam Session where they left off provided that the primary parameters were not changed during Jam Session shutdown.

Starting a Jam Session

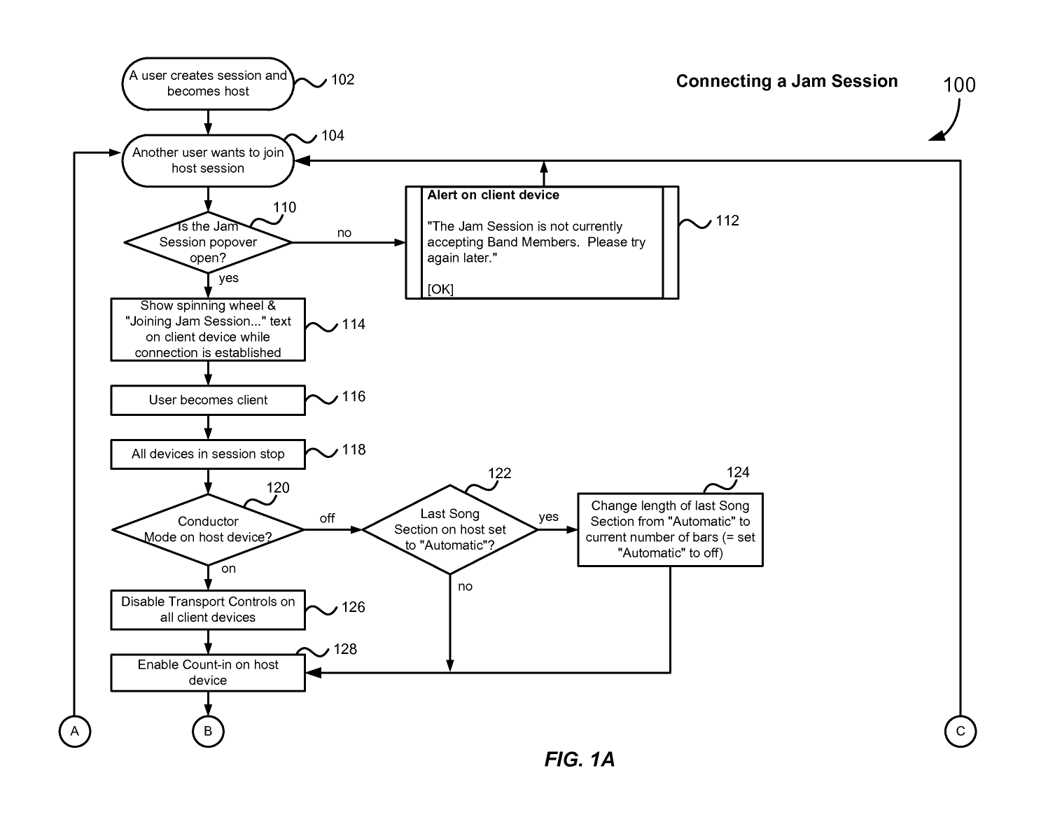

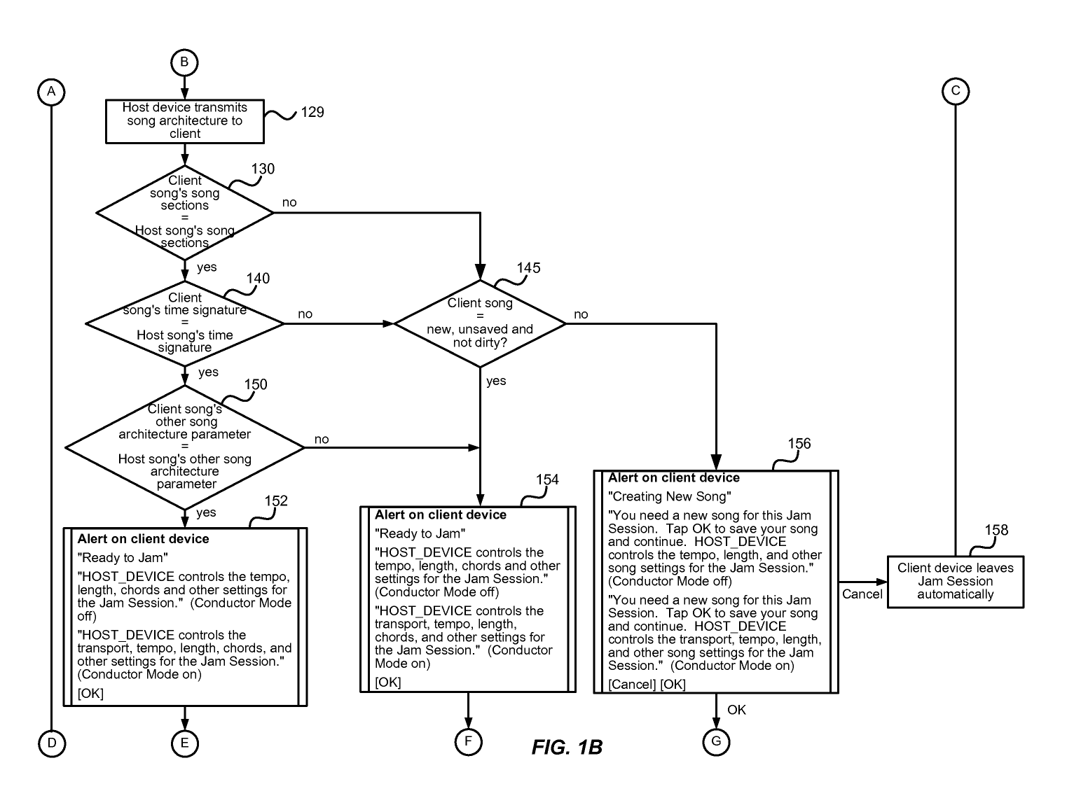

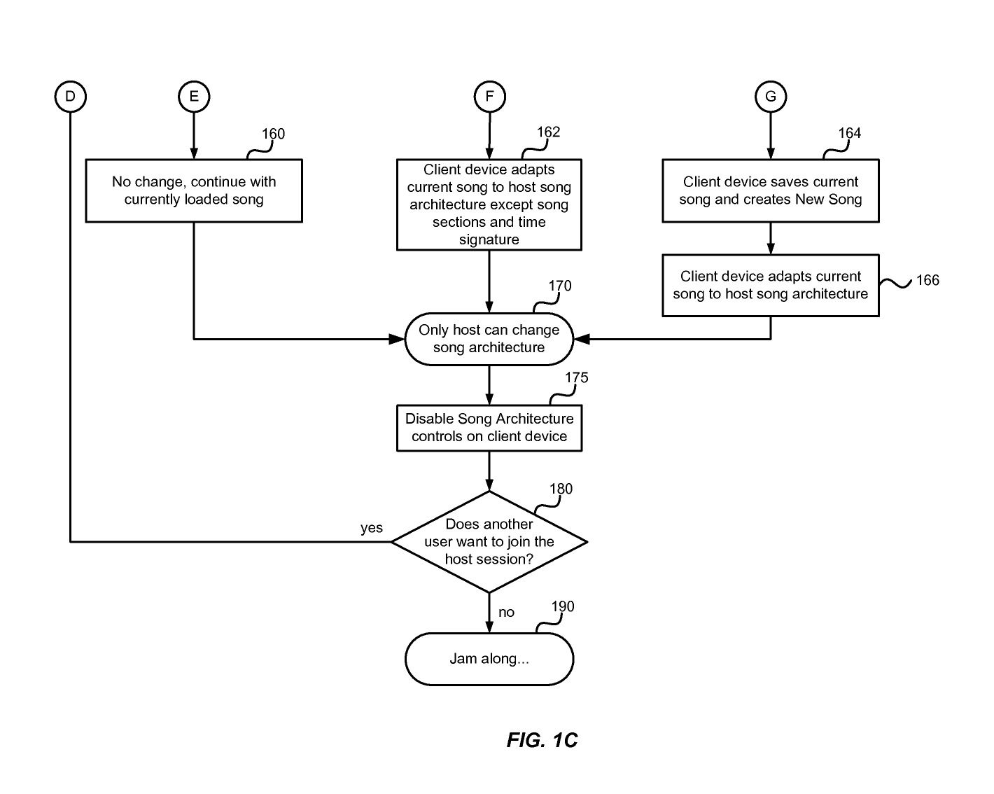

FIGS. 1A-1C are simplified flow diagrams illustrating aspects of a method 100 of creating a jam session between electronic devices, according to certain embodiments of the invention. Method 100 is performed by processing logic that may comprise hardware (e.g., circuitry, dedicate logic, etc.), software (which as is run on a general purpose computing system or a dedicated machine), firmware (embedded software, or any combination thereof. In one embodiment, method 100 is performed by the processor 1010 of FIG. 10.

Referring to FIG. 1A, method 100 includes a user creating a jam session (102). The jam session creator (“host”) becomes the bandleader of the created jam session and the bandleader device becomes the “host device.” The host device can send an alert message that may be detected by local devices (e.g., GarageBand™ operating Jam Session functionality) indicating that a Jam Session has been created and is available or unavailable to join. At 104, the host device receives a request from another user (i.e., a first client device) to join the host-initiated jam session. Upon receiving a client request to join the jam session, at 110, it is determined if the jam session pop-over menu is open or not on the client device. If not open, the client receives an alert indicating that the host's jam session is not currently accepting band members (112), and the client can try to join again at a later time (104). An open jam session pop-over menu indicates that the client device can join the host session. If it is determined in 110 that the jam session pop-up menu is open on the client device, then at 114, the client's request to join the jam session is acted upon and a message may be displayed on the client indicating that the client device is establishing a connection with the host jam session. At 116, the host-client connection is established and the requesting client device is made a member or participant of the jam session. At 118, any playback or recording currently running on devices participating in the jam session is stopped (118). At 120, it is determined if a conductor mode (i.e., bandleader control, as shown in 820 of FIG. 8) on the host device is turned off. If turned off, then at 122, a check is made if the last song section on the host is set to “automatic.” If set to automatic, then at 124, the length of the last song section changes from “automatic” to the current number of bars (i.e., the automatic mode is turned off). If it is determined in 122 that the last song section of the host is not set to automatic, then processing continues with 128 wherein a count-in feature is enabled on the host device and the method then continues on to B, as described below. If it is determined in 120 that the conductor mode on the host device is turned on, then at 126, the transport controls (e.g., play, pause, record) on all client devices are disabled. As a result of 126, the host has sole control of the transport controls for each device for the host-initiated jam session. The count-in feature is then enabled on the host device at 128 and the method then continues on to B depicted in FIG. 1B.

Referring to FIG. 1B, from point B, at 129, the host device transmits a host song architecture to the one or more clients connected to the jam session. A song architecture can include primary parameters and secondary parameters (i.e., “other song architecture parameters,” as shown in 150 of FIG. 1B). In some embodiments, the primary parameters include song section data and time signature data. The secondary parameters can include tempo data, key signature data, custom chord data, master effects preset selection data, count-in data, and fade out data. At 130, each client device determines whether their current client song's song section matches the host song's song sections.

If it is determined in 130 that the client song's song section does not match the host song's song section, then at 145, the client device determines whether the client's song is new or unsaved and not dirty. A song is considered “unsaved and not dirty” if the song is a newly created song and does not contain any significant user input (i.e., the user input is insignificant insofar that altering or removing such user input would not be perceived as data loss by the user). For example, a recorded audio track may be significant, while only changing a secondary parameter with no recorded audio may be insignificant. If it is determined in 145 that the client's song is new or unsaved and not dirty, then at 154, the client device alerts the client user that the session is ready to begin a jam session. In some cases, at 154, the client device may optionally alert the client that the host device controls the tempo, length, chords and other setting for the jam session if the conductor mode of the client device is off. Alternatively, in 154, the client device may alert the client that the host device controls the transport, tempo, length, chords, and other settings for the jam session, if the conductor mode is turned on. In 154, the client device may prompt the client to proceed (e.g., press “OK”) and the method then proceeds to F in FIG. 1C.

If it is determined in 145 that the client song is neither new nor unsaved and not dirty, then at 156, the client device can alert the client that a new song is being created. As part of 156, in cases when the conductor mode is off, the client device can alert the client that a new song is needed for the jam session and provide an option to save the current song. The client device can further alert the client that the host device controls the tempo, length, and other song settings for the jam session. In cases when the conductor mode is on, the client device can alert the client that a new song is needed for the jam session and provide an option to save the current song. In addition, the client device can further alert the client that the host device controls the transport, tempo, length, and other song settings for the jam session. The client device may then prompt the client to either continue (e.g., press “OK”) or cancel. If the client continues, the method then proceeds to G in FIG. 1C. If the client cancels, then at 158, the client device leaves (i.e., disconnects) from the jam session automatically and proceeds to C and 104 (FIG. 1A) where the client can try to reconnect to the host session.

Referring back to 130, if it is determined that the client song's song sections match the host song's song sections, the client device at 140 determines if the client song's time signature matches the host song's time signature. If it is determined in 140 that the client song's time signature does not match the host song's time signature, then processing continues with 145, as described above, where it is determined if the client song is new or unsaved and not dirty. If it is determined in 140 that the client and host songs do share the same time signature, then in 150, the client device determines if the client song's other song architecture parameters (e.g., tempo, custom chords, etc.) match the host song's other song architecture parameters. If they do not match, the method proceeds to 154, as described above. If they do match, at 152, the client device can display an alert that the device is ready to begin the jam session. In some embodiments, as part of 152, the client device may alert the client that the host device controls the tempo, length, chords and other setting for the jam session if the conductor mode of the client device is off. Alternatively, the client device may alert the client that the host device controls the transport, tempo, length, chords, and other settings for the jam session, if the conductor mode is turned on. The client device prompts the client to proceed (e.g., press “OK”) and the method proceeds to E, as depicted in FIG. 1C.

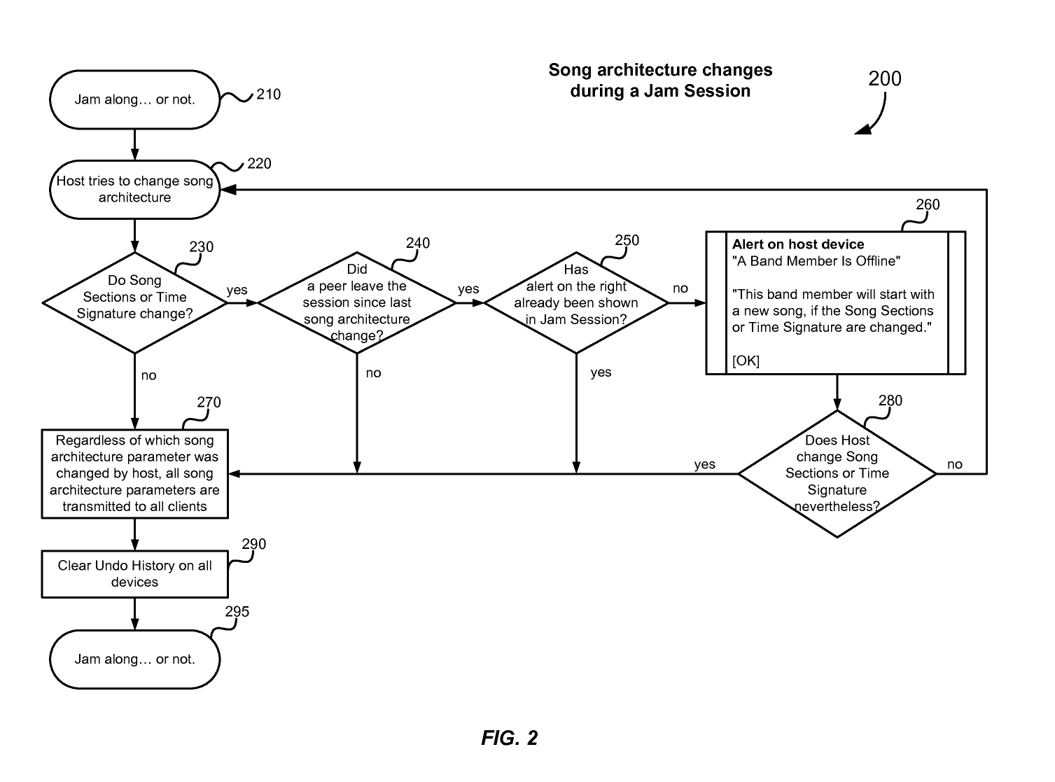

Referring to point E of FIG. 1C, the jam session continues at 160 with the currently loaded host song because all of the song architecture parameters match. Once the song architectural parameters are matched between the host and client(s), further song architectural changes can be initiated by the host device at 170, and the song architecture controls are disabled on the client devices (175). At 180, if another user wants to join the host initiated jam session, the method returns to 104 of FIG. 1A, as described above. If, at 180, no further users wish to join the host jam session, the jam session begins at 190, as described in FIG. 2. It should be noted that in alternative embodiments, any device in the jam session can initiate song architectural parameter changes.

Referring to point F, the client device at 162 adapts the secondary parameters of the current client song to the secondary parameters of the host song architecture. As described above, further song architectural changes can be initiated by the host device at 170 and the song architecture controls are disabled on the client devices at 175. At 180, if another user wants to join the host initiated jam session, the method returns to 104 of FIG. 1A. If no further users wish to join the host jam session at 180, the jam session begins at 190.

Referring to point G, if the client song is not new nor unsaved and not dirty at 156, the client device, at 164, saves the current song and creates a new song. The client device then adapts the current song to the host song architecture at 166, including the primary and secondary parameters. At this stage, further song architectural changes can be initiated by the host device at 170 and the song architecture controls are disabled on the client devices at 175. At 180, if another user wants to join the host initiated jam session, the method returns to 104 of FIG. 1A. If no further users wish to join the host jam session at 180, the jam session begins at 190, as described in FIG. 2.

It should be appreciated that the specific steps illustrated in FIGS. 1A-1C provide a particular method 100 of starting a jam session, according to an embodiment of the present invention. Other sequences of steps may also be performed according to alternative embodiments. In certain embodiments, method 100 may perform the individual steps in a different order, at the same time, or any other sequence for a particular application. Moreover, the individual steps illustrated in FIGS. 1A-1C may include multiple sub-steps that may be performed in various sequences as appropriate to the individual step. Furthermore, additional steps may be added or removed depending on the particular applications. One of ordinary skill in the art would recognize and appreciate many variation, modification, and alternatives of method 100.

Song Architecture Changes Made During a Jam Session

In certain embodiments, if the host or client attempts to alter song architecture parameters during or after a jam session, the song may be rendered incompatible between peers. Alerts may be set up to inform the host and/or clients of these situations to prevent these issues. In one example, if one or more clients (i.e., client devices) leave a Jam Session, and the host attempts to change a primary parameter (e.g., song sections or time signature), an alert may pop up that informs the host that such changes may render the song incompatible for the missing band members in the event that they wish to rejoin the jam session at a later time. For example, if a client device is momentarily disconnected from a jam session and the host device changes the time signature during the absence of the client device, the client device may not be able to rejoin the jam session because a primary parameter was changed, thus making the host device song and client device song incompatible. It should be noted that the use of alerts, the frequency of their use, and their application to different scenarios can be customized as per each host/client's preference. Similarly, if a client device that was previously a participant in a jam session tries to change primary parameters of a song used in the Jam Session while offline, the client device may display a similar alert that changes may render the song incompatible for the jam session.

FIG. 2 is a simplified flow diagram illustrating aspects of a method 200 of initiating song architecture changes during a jam session, according to an embodiment of the invention. Method 200 is performed by processing logic that may comprise hardware (e.g., circuitry, dedicate logic, etc.), software (which as is run on a general purpose computing system or a dedicated machine), firmware (embedded software, or any combination thereof. In one embodiment, method 200 is performed by the processor 1010 of FIG. 10.+

Referring to FIG. 2, method 200 begins at 210 with the host (i.e., using a host device) or client(s) (i.e., using a client device) free to jam along during the jam session or not. For example, a song can begin and a client can decide to sit out the jam session, participate in select sections of the song, or jam along during the entire song. At 220, the host attempts to change a song architecture parameter on the host device. At 230, if the host changes do not change any of the primary parameters, including the song sections or time signature, the host transmits some or all host song architecture parameters, at 270, to the one or more client devices in the current jam session. The client song architecture parameters adapt to the host song, as described above. The undo history for all devices can be subsequently cleared at 290 and each jam session participant can continue to jam along in the current session at 295.

In some embodiments, if the host device changes the song section or time signature at 230, but a client device has not left the jam session since the last song architecture was changed at 240, the host device can transmit all host song architecture parameters to the one or more clients in the current jam session at 270 and proceed as described above. If a client device has left a session since the last song architecture change, at 240, and the host is alerted that changing the song architecture will prevent the former clients to join the session again without having to automatically load a new song, at 250, then the host device can transmit all host song architecture parameters to the one or more client devices in the current jam session, at 270, and proceed as described above. If, at 270, the time signature or song sections changes, a peer (e.g., client device) leaves the jam session since the last song architecture change, at 240, and host device is not alerted that a band member is offline, at 250, then the host device alerts the host (e.g., host device user) that a band member is offline and advises the host that the band member will start with a new song, at 260, if the song sections or time signature is changed. If the host changes the song sections or time signature on the host device despite the alert, then, at 280, the host device transmits all host song architecture parameters to the one or more clients in the current jam session, at 270, and proceeds as described above. If the host (using the host device) does not change the song sections or time signature, at 280, after receiving the alert, at 260, method 200 can return to 220.

It should be appreciated that the specific steps illustrated in FIG. 2 provides a particular method 200 of initiating song architecture changes during a jam session, according to an embodiment of the present invention. Other sequences of steps may also be performed according to alternative embodiments. In certain embodiments, method 200 may perform the individual steps in a different order, at the same time, or any other sequence for a particular application. Moreover, the individual steps illustrated in FIG. 2 may include multiple sub-steps that may be performed in various sequences as appropriate to the individual step. Furthermore, additional steps may be added or removed depending on the particular applications. One of ordinary skill in the art would recognize and appreciate many variation, modification, and alternatives of method 200.

Song Architecture Changes Made Offline

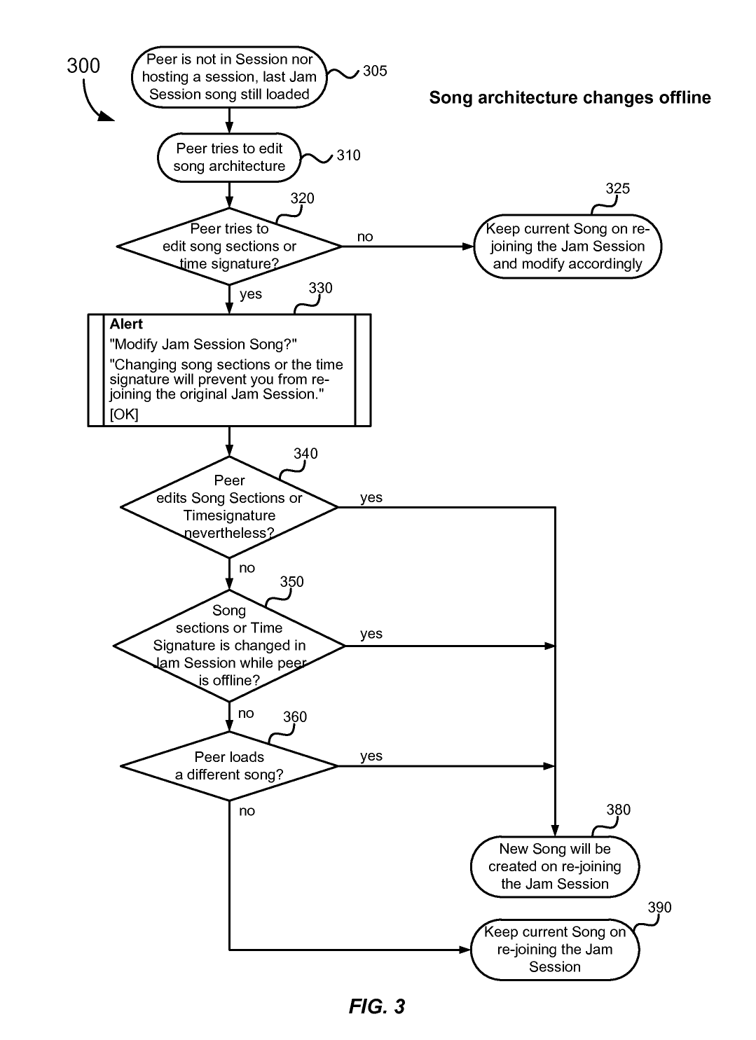

FIG. 3 is a simplified flow diagram illustrating aspects of a method 300 of initiating song architecture changes offline, according to an embodiment of the invention. Method 300 is performed by processing logic that may comprise hardware (e.g., circuitry, dedicate logic, etc.), software (which as is run on a general purpose computing system or a dedicated machine), firmware (embedded software, or any combination thereof. In one embodiment, method 300 is performed by the processor 1010 of FIG. 10.

Referring to FIG. 3 at 305, if a peer device (e.g., host or client device) is not in a jam session nor hosting a session, the last jam session song will still be loaded in memory of that peer device. At 310, a peer device tries to edit the song architecture of the last song. At 320, if the peer device does not edit any song sections or the time signature, the last song, at 325, remains active when rejoining the jam session. In some cases, the song may be modified to align secondary song architecture parameters (e.g., tempo, key signature, etc.).

At 320, if the peer (using a host or client device) tries to edit the song sections or the time signature (i.e., primary song architecture parameters), an alert may be displayed on the peer device (e.g., client device) prompting the user to verify if they intend to modify the jam session song. The alert may notify the peer (on the peer device) that changing song sections or time signatures can prevent them from re-joining the original jam session. In some cases, the alert may only be shown the first time. Alerts may be enabled, disabled, or configured by host or client devices as needed. If, at 340, the peer device follows through and edits song sections or changes the time signature of the jam session song, then, at 380, a new song is created on the peer device when rejoining the jam session. At 340, if the peer does not edit the primary architectural song parameters, but they are changed in the jam session while the peer is offline, at 350, a new song is created on the peer device at 380 when rejoining the jam session. If the primary architectural song parameters are not changed by the peer device, at 340, or in the jam session at 350, but the peer loads a different song instead, at 360, a new song is created on the peer device when rejoining the jam session at 380. If none of the cases 340, 350, 360 exist, the current song is kept when rejoining the jam session at 390.

It should be appreciated that the specific steps illustrated in FIG. 3 provides a particular method 300 of initiating song architecture changes offline, according to an embodiment of the present invention. Other sequences of steps may also be performed according to alternative embodiments. In certain embodiments, method 300 may perform the individual steps in a different order, at the same time, or any other sequence for a particular application. Moreover, the individual steps illustrated in FIG. 3 may include multiple sub-steps that may be performed in various sequences as appropriate to the individual step. Furthermore, additional steps may be added or removed depending on the particular applications. One of ordinary skill in the art would recognize and appreciate many variation, modification, and alternatives of method 300.

Accessing Host/Client Songs during Jam Session

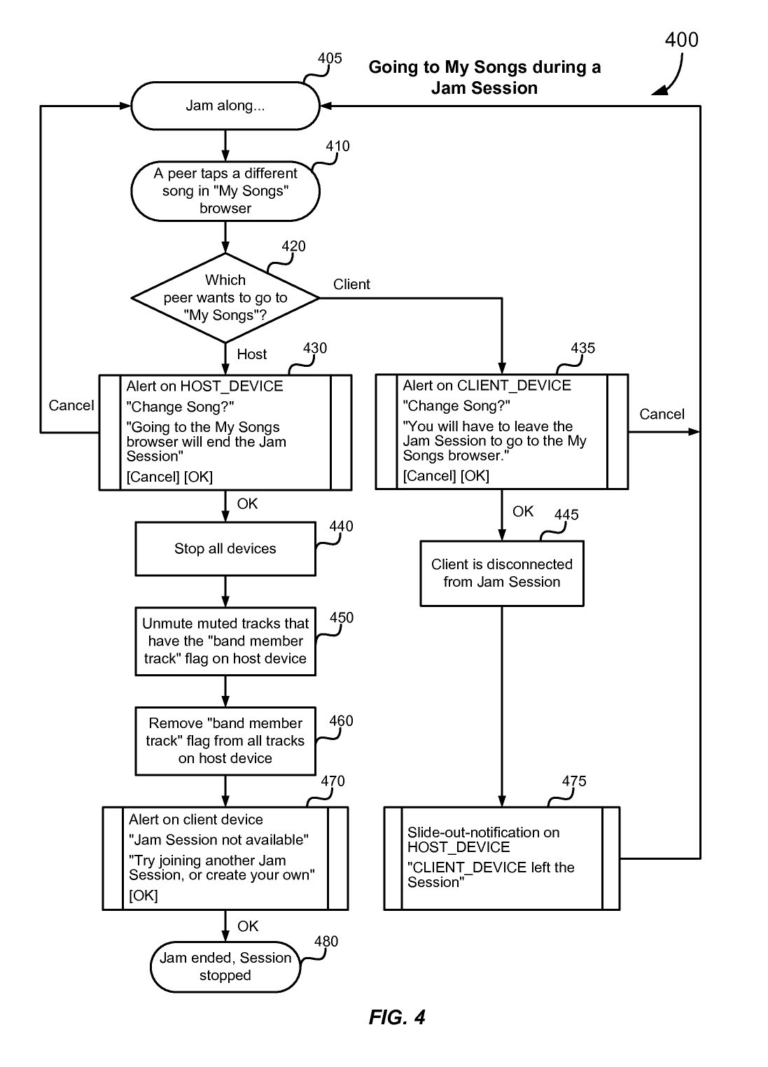

FIG. 4 is a simplified flow diagram illustrating aspects of a method 400 of accessing host or user songs during a jam session, according to an embodiment of the invention. Method 400 is performed by processing logic that may comprise hardware (e.g., circuitry, dedicate logic, etc.), software (which as is run on a general purpose computing system or a dedicated machine), firmware (embedded software, or any combination thereof. In one embodiment, method 400 is performed by the processor 1010 of FIG. 10.

Referring to FIG. 4, a jam session is under way at 405. At 410, a peer selects (e.g., taps) a different song in a song browser. At 420, if the peer is a host device, the host device displays an alert at 430. The alert may include a prompt asking for confirmation to change the song. In some cases, the alert informs the host (on the host device) that accessing the song browser will end the current jam session. It should be noted that alerts may be optional and can be enabled, disabled, or modified as required. At 430, if the host cancels the song change request, the method can return to the ongoing jam session at 405. If the host continues with the song change, the host device stops all client devices at 440, un-mutes muted tracks that have a “band member track” flag on the host device at 450, and removes a “band member track” flag from all tracks on host device at 460. At 470, the host subsequently sends an alert to each client device informing the client that the jam session is no longer available. At 480, the jam session ends and the session is stopped.

At 420, if the peer accessing its song browser is a client, the client device displays an alert requesting confirmation to change the song. In some cases, the alert informs the client that they have to leave the current jam session in order to access the song browser. It should be noted that alerts may be optional and can be enabled, disabled, or modified as required. At 435, if the client cancels the song change request, method 400 returns to the ongoing jam session at 405. If the client continues with the song change, the client disconnects from the jam session at 445. Following disconnection of the client, the host device can receive a notification that the client device left the jam session, at 475, and the method returns to the ongoing jam session at 405.

It should be appreciated that the specific steps illustrated in FIG. 4 provides a particular method 400 of accessing archived songs during a jam session, according to an embodiment of the present invention. Other sequences of steps may also be performed according to alternative embodiments. In certain embodiments, method 400 may perform the individual steps in a different order, at the same time, or any other sequence for a particular application. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize and appreciate many variation, modification, and alternatives of method 400.

It should be noted that when a Jam Session is created on a host device, the Jam Session can be assigned a Universally Unique Identifier (UUID). The UUID is typically transmitted on the initial client configuration and can be used to trigger alerts if a user (utilizing a host or client device) tries to change song architecture parameters while offline. The host can optionally use the UUID to automatically access song directories of clients for finding and uploading Jam Session songs with a UUID that matches the Jam Session song UUID on the host. This may be useful in which former participants of a Jam Session reconnect and wish to continue work on the song of that particular Jam Session, but loaded a different song while being offline.

Leaving a Jam Session

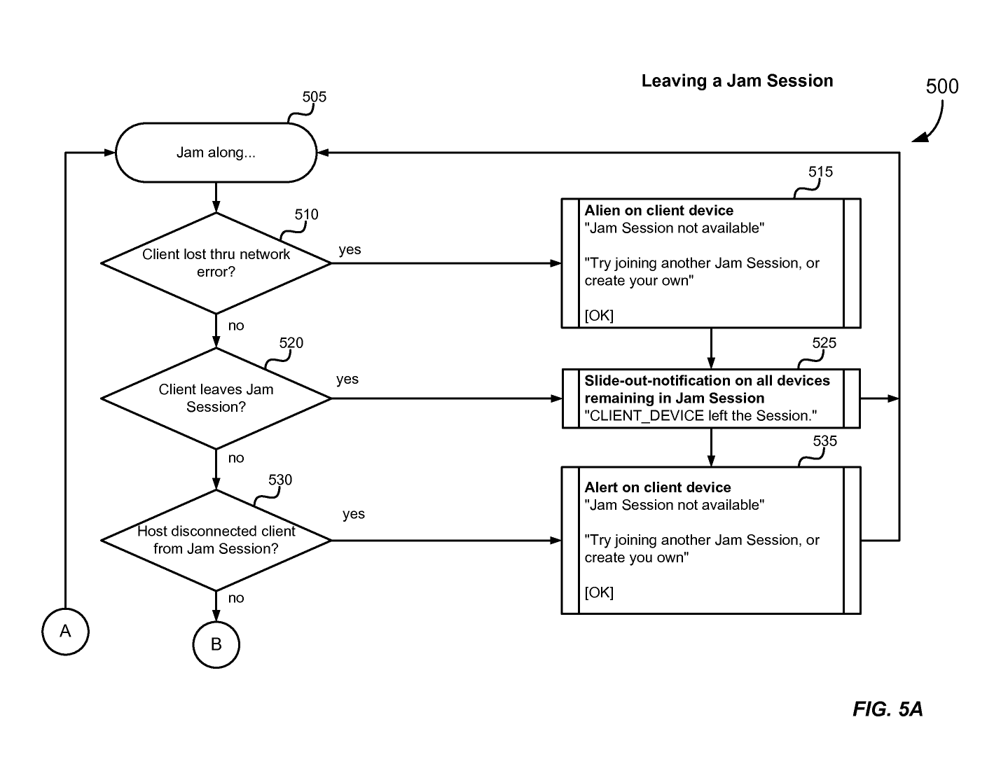

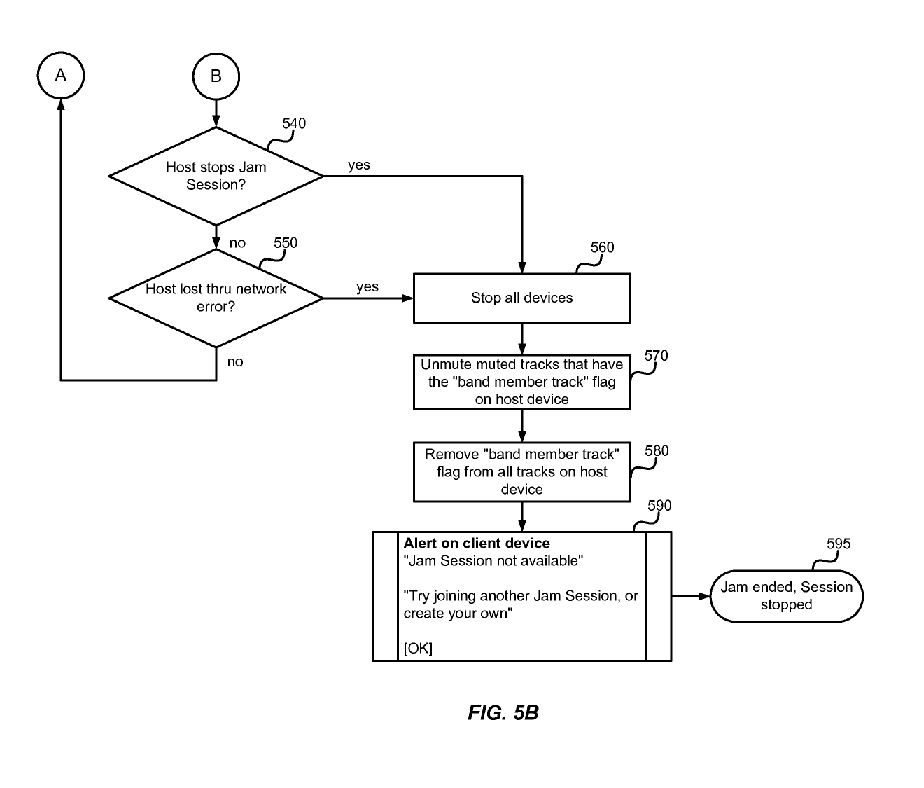

FIGS. 5A-5B are simplified flow diagrams illustrating aspects of a method 500 of leaving a jam session, according to an embodiment of the invention. Method 500 is performed by processing logic that may comprise hardware (e.g., circuitry, dedicate logic, etc.), software (which as is run on a general purpose computing system or a dedicated machine), firmware (embedded software, or any combination thereof. In one embodiment, method 500 is performed by the processor 1010 of FIG. 10.

Referring to FIG. 5A, a jam session is under way at 505. At 510, if a client is lost through a network error or disconnection, the client device alerts the client that the jam session is no longer available, at 515. The client device can optionally suggest trying another jam session or creating a new one. At 525, Each remaining host/client in the jam session receives a notification that the client device left the session and the jam session continues at 505. At 520, if the client leaves the jam session, each remaining host/client in the jam session receives a notification that the client device left the session (525), and the jam session continues at 505. It should be noted that if multiple clients leave the session at the same time, the notifications (e.g., alerts) can be queued or displayed as a list. At 530, if the host disconnects the client from the jam session, the disconnected client device alerts the client that the jam session is not available and the jam session continues at 505.

Referring to FIG. 5B at B, if the host does not disconnect the client from the jam session at 530, the host does not stop the jam session (540), and the host is not lost through a network error or disconnection, at 550), the jam session continues at 505. At 540, if the host stops the jam session or the host is lost or disconnected through network error, at 550, the host stops all devices in the jam session, at 560. At 570, the host un-mutes all muted tracks that have a “band member track” flag on the host device. At 580, the host device removes the “band member track” flag from all tracks on the host device and alerts all connected clients that the jam session is not available at 590. At 595, the jam session ends.

It should be appreciated that the specific steps illustrated in FIGS. 5A-5B provide a particular method 500 of leaving a jam session, according to an embodiment of the present invention. Other sequences of steps may also be performed according to alternative embodiments. In certain embodiments, method 500 may perform the individual steps in a different order, at the same time, or any other sequence for a particular application. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize and appreciate many variation, modification, and alternatives of the method.

Collecting Recordings After a Jam Session

At the end of a jam session, the band leader (i.e., host device) can collect all recordings from each peer device in the jam session. The host can manually collect recordings from one or more client devices, or set up an automated collection process. The jam session control user interface can provide a list of peers (e.g., client devices) connected to a current jam session to allow the band leader to identify which client devices to retrieve recordings from. In some embodiments, the “auto-collect recordings” and “bandleader control” features control the recording collection process.

With the auto-collect and bandleader controls on, the bandleader (via the host device) can automatically collect unmuted and/or soloed tracks from band members (e.g., client devise) after recording stops. Tracks collected from band members may be flagged as “band member tracks” on the bandleader device. In some cases, all “band member tracks” are automatically muted as they are collected by the bandleader device (e.g., host). The bandleader can optionally unmute collected tracks after collection. In some embodiments, the host device automatically deletes muted “band member tracks” when a recording is initiated and saves unmuted tracks. Typically, tracks that are both muted and flagged as a band member track are deleted when starting a new recording. The auto-collect and bandleader controls are typically a default setting, but can be customized to user preference.

With the auto-collect or bandleader controls turned off, the bandleader has to manually collect recordings from each client device. In certain embodiments, if the band leader ends the session (e.g., terminates session by pressing “Stop Session” in a Jam Session pop-up menu), the “band member track” flag is removed from all “band member tracks,” and any muted “peer tracks” (automatically or manually muted) are unmuted.

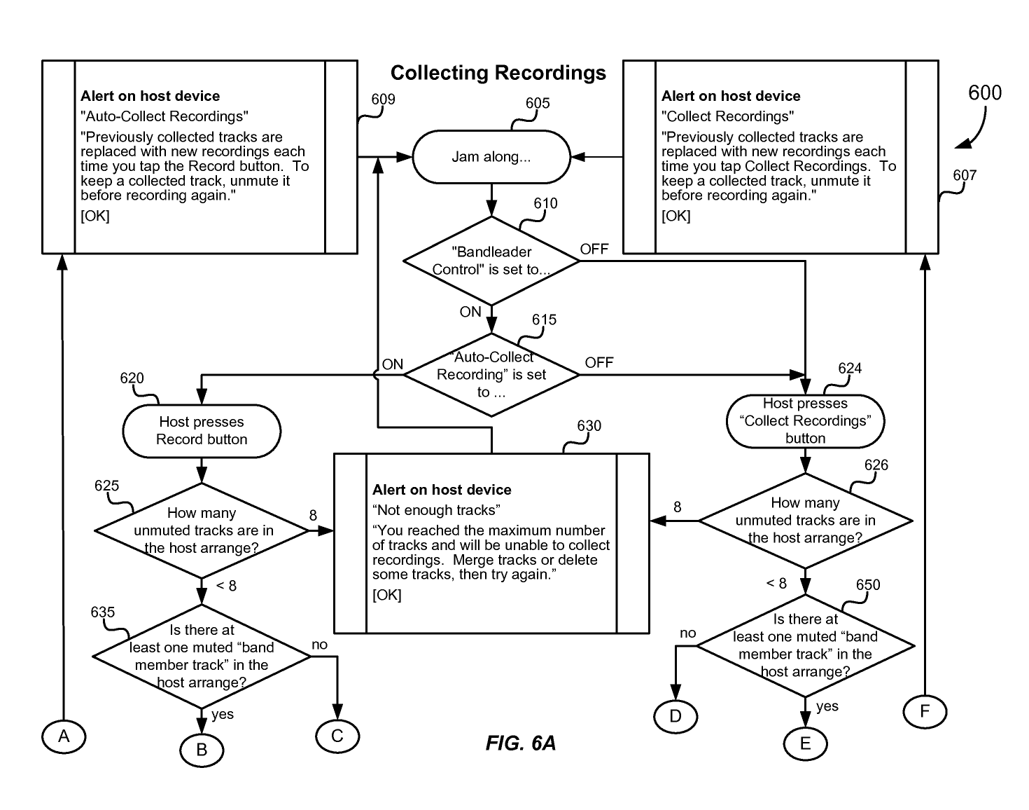

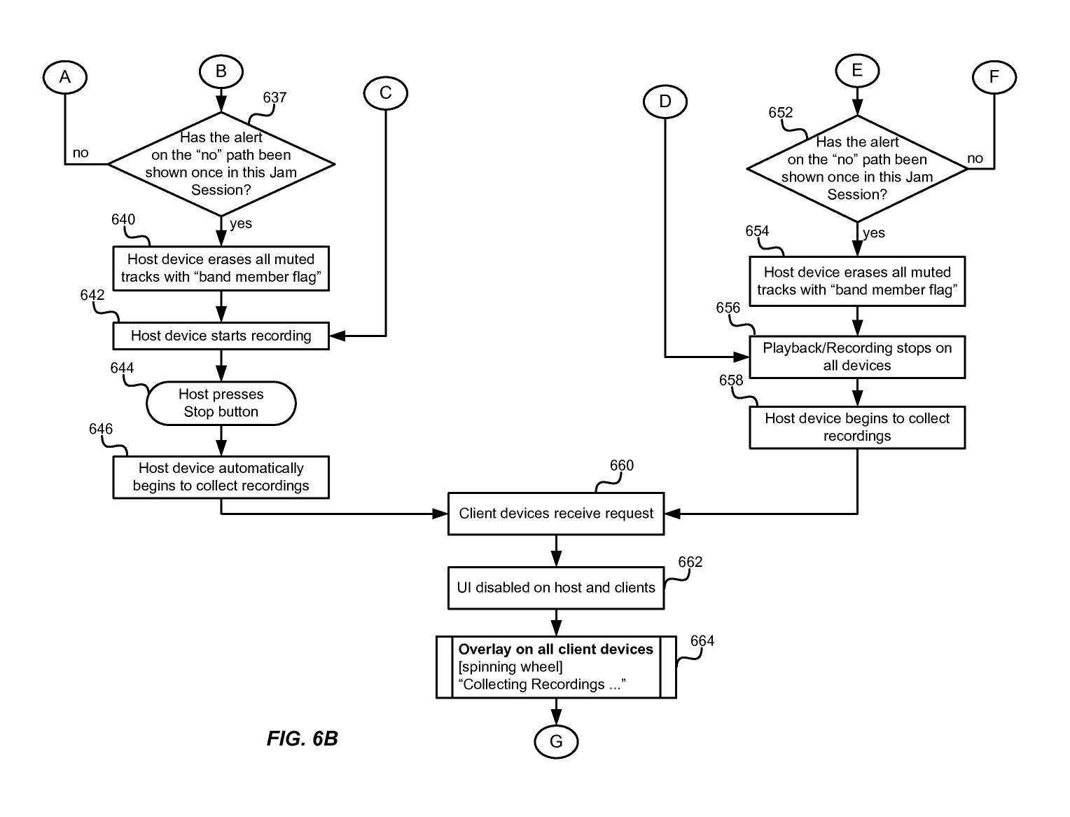

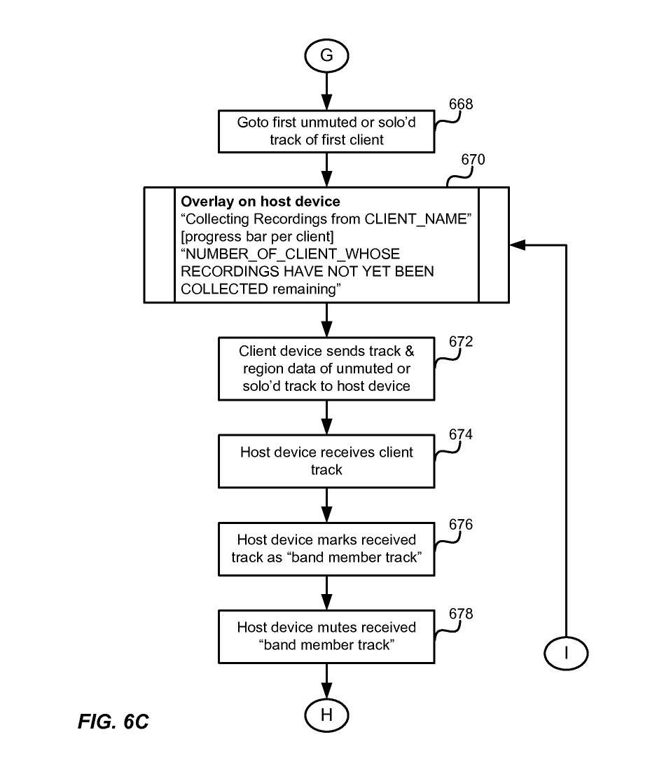

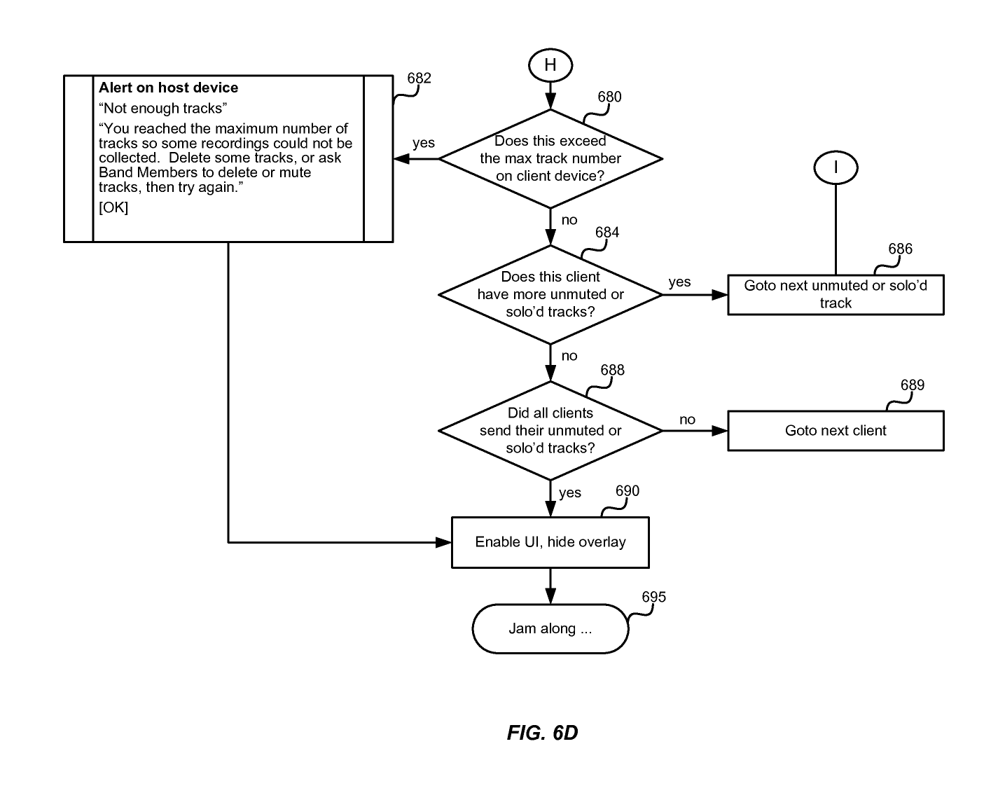

FIGS. 6A-6C are simplified flow diagrams illustrating aspects of a method 600 of collecting recordings in a jam session, according to an embodiment of the invention. Method 600 is performed by processing logic that may comprise hardware (e.g., circuitry, dedicate logic, etc.), software (which as is run on a general purpose computing system or a dedicated machine), firmware (embedded software, or any combination thereof. In one embodiment, method 600 is performed by the processor 1010 of FIG. 10.

Referring to FIG. 6A, method 600 starts at 605 with the jam session already underway. As described above, jam session typically includes a band leader (e.g., the host device) and one or more client devices simultaneously playing along in a “live” context. At the end of each jam session, the band leader can collect the recordings from each client device to store or edit the complete song. There are a variety of ways to collect the recordings from each client including both manual and automatic processes. At 610, if the band leader control is turned off in the host device, the host can collect the recordings from the client devices by manual selection at 624. For example, the host can press a “collect recordings” button to manually initiate the process of retrieving recording from each of the client devices in the jam session. At 626, the host device determines how many unmuted tracks are in the host arrange (e.g., how many tracks are currently stored on the host device). If eight tracks are in the host arrange, at 630 the host device can alert the host (e.g., user) that there are not enough tracks available to collect any additional recordings. The host device can optionally suggest that the host can merge tracks (i.e. bounce tracks) or delete tracks to free up space and try again. For example, tracks 1 and 2 can be merged into a composite single track (track 2), allowing the host to delete track 1 and use it as an additional track. In such cases, the method at 605 returns to the on-going jam session and the host can begin the process again. At 626, if there are less than eight tracks in the host arrange, the host determines if there is at least one muted “band member track” already stored in the host arrange, at 650. If there is at least one track muted in the host arrange, method 600 continues to E. If there is not at least one track muted in the host arrange, the method continues to D. D and E are discussed below with respect to FIG. 6B.

At 610, if the band leader control is turned on, the host device determines whether an auto-collect mode is enabled at 615. The auto-collect mode can automatically collect all recordings from each client device at the end of a session. At 615, if the auto-collect mode is turned off, the host device at 624 can collect the recordings by manual selection and method 600 continues as described above. If the auto-collect mode is turned on, the host can press a record button on a transport control of the host device at 620, and the host device determines how many unmuted tracks are in the host arrange at 625. If eight tracks are currently in the host arrange, at 630 the host device can alert the host that there are not enough tracks available to collect any additional recordings as described above. At 625, if there are less than eight tracks in the host arrange, the host device determines at 650 if there is at least one muted “band member track” already stored in the host arrange. If there is at least one band member track muted in the host arrange, the method continues to B. If there is not at least one band member track muted in the host arrange, the method continues to C. Both B and C are discussed below with respect to FIG. 6B.

Referring to FIG. 6B at B, if there is at least one muted “band member track” in the host arrange, at 635, the host device determines whether an alert on the “no” path has been shown at least once in the current jam session at 637. If no alert has been given, the host device alerts the host that the auto-collect recordings mode is enabled (see 609 of FIG. 6A from A/637). The host device can optionally inform the host that previously collected tracks will be replaced with new recordings each time the record button is tapped and that collected tracks should be unmuted prior to recording in order to prevent them from being deleted or recorded over. The method returns to the on-going jam session (605 of FIG. 6A) and the host can begin the recording collection process again. If the alert has been given in the current jam session, the host device erases all muted tracks with a band member flag at 640. Once all muted tracks are erased, the host device begins recording at 642. Similarly, if there is at least one muted band member track in the host arrange (see 635 at FIG. 6A), the host device begins recording (642 from C/635). At 644, the host presses the stop button and the host device automatically begins the process of collecting all recordings from each client in the jam session at 646. At 660, each client device in the jam session receives the request for recordings from the host device.

Referring to FIG. 6B at E, if there is at least one muted “band member track” in the host arrange at 650, the host device determines whether an alert on the “no” path has been shown at least once in the current jam session at 652. If no alert has been given, the host device alerts the host that the collect recordings mode is enabled (at 607 of FIG. 6A from F/652). The host device can optionally inform the host that previously collected tracks will be replaced with new recordings each time the record button is tapped and that collected tracks should be unmuted prior to recording in order to keep them. The method returns to the on-going jam session (at 605 of FIG. 6A) and the host can begin the recording collection process again. If the alert has been given in the current jam session, the host device erases all muted tracks with a band member flag at 654. At 656, playback and recording stops on all devices. Similarly, if there is at least one muted band member track in the host arrange (at 650 at FIG. 6A), playback and recording stops on all devices (at 656 from D/650). At 658, the host begins the process of collecting all recordings from each client device in the jam session. At 660, each client device in the jam session receives a request to collect recording from the host device (from 646 and 658). At 662, both the host and client devices disable their user interfaces (UI) during the collection process and displays an alert that the recording collection process is underway at 664. Method 600 continues at G.

Referring to FIG. 6C at G, at 668, method 600 continues by accessing a first unmuted or soloed track of a first client device in the jam session. The host device displays a message alerting the host that it is currently collecting recordings from the first client device (e.g., with an accompanying progress bar for each client) and indicates the number of remaining client devices whose recordings have not yet been collected, at 670. The client devices sends their respective track and region data of unmuted or soloed tracks to the host device at 672. At 674, the host device receives the client track, marks the received track as a “band member track” at 676, and mutes the received band member track at 678. Method 600 continues at H.

Referring to FIG. 6D at H, once the host device receives the band member track from a client device (e.g., first client device), the host device determines if the maximum number of tracks has been exceeded, at 680. If the maximum number of tracks on the host device has not been exceeded, the host device determines if the client (e.g., first client) has any additional unmuted or soloed tracks, at 684. At 686, if the client device has additional unmuted or soloed tracks, the client device sends the track and region data for the additional tracks to the host device, at 672, and continues as described above. At 684, if the client device does not have any additional tracks, the host device determines if all of the client devices in the jam session have sent their unmuted or soloed tracks, 688. If all client devices in the jam session are not accounted for, the host device accesses the next client device, at 689, displays a message alerting the host that it is currently collecting recordings from the next client device (i.e., second client), and indicates the number of remaining clients whose recordings have not yet been collected, at 670. At 672, the second client device sends the track and region data of unmuted or soloed tracks to the host device and continues as described above. At 688, if all unmuted or soloed tracks from all client devices are accounted for, the UI is enabled and the alert message is cleared, at 690. Referring back to 680, if the maximum number of tracks on the host device has been exceeded, the host device displays a message alerting the host that there are not enough tracks available in the jam session to collect additional recordings from the clients, at 682. The host device can optionally inform the host that the maximum number of tracks has been reached and some of the recordings were not collected, followed by suggestions that could free up one or more tracks on the host device including deleting tracks on the host device, or asking band members (i.e., clients) via their client devices to delete or mute tracks to allow the collections of recordings to occur. From 682, the UI is enabled and the alert message(s) is cleared. At 695, the jam session continues and all functions (transport controls) are returned, at 695.

It should be appreciated that the specific steps illustrated in FIGS. 6A-6D provide a particular method of collecting recordings after a jam session concludes, according to an embodiment of the present invention. Other sequences of steps may also be performed according to alternative embodiments. In certain embodiments, method 600 may perform the individual steps in a different order, at the same time, or any other sequence for a particular application. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize and appreciate many variation, modification, and alternatives of the method.

In some embodiments, track UUIDs can be used for marking tracks as client tracks to preserve a reordering of tracks and, if desired, to prioritize already imported client tracks over newly created tracks. UUIDs may also be assigned to audio and sampler files to avoid duplicated transmission of data already existing on the host.

In further embodiments, the host (i.e., via the host device) can mark tracks received from the client device as client tracks. The host may delete muted client tracks when the Collect Recordings function is initiated. The client track flag is typically removed upon editing a track or opening the Touch Instrument of a track. In some cases, when the Jam Session is disconnected from the host side, muted client tracks are unmuted, and the client flags can be removed from the client tracks.

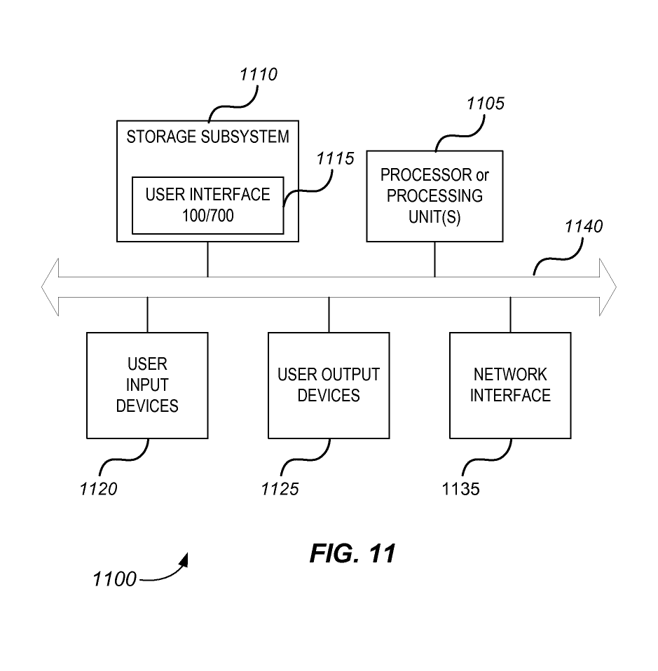

FIG. 11 illustrates a computer system 1100 according to an embodiment of the present invention. The user interfaces described herein (e.g., interface 100 and 700) can be implemented within a computer system such as computer system 1100 shown here. Computer system 1100 can be implemented as any of various computing devices, including, e.g., a desktop or laptop computer, tablet computer, smart phone, personal data assistant (PDA), or any other type of computing device, not limited to any particular form factor. Computer system 1100 can include processing unit(s) 1105, storage subsystem 1110, input devices 1120, output devices 1125, network interface 1135, and bus 1140.

Processing unit(s) 1105 can include a single processor, which can have one or more cores, or multiple processors. In some embodiments, processing unit(s) 1105 can include a general purpose primary processor as well as one or more special purpose co-processors such as graphics processors, digital signal processors, or the like. In some embodiments, some or all processing units 1105 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 1105 can execute instructions stored in storage subsystem 1110.

Storage subsystem 1110 can include various memory units such as a system memory, a read-only memory (ROM), and a permanent storage device. The ROM can store static data and instructions that are needed by processing unit(s) 1105 and other modules of electronic device 1100. The permanent storage device can be a read-and-write memory device. This permanent storage device can be a non-volatile memory unit that stores instructions and data even when computer system 1100 is powered down. Some embodiments of the invention can use a mass-storage device (such as a magnetic or optical disk or flash memory) as a permanent storage device. Other embodiments can use a removable storage device (e.g., a floppy disk, a flash drive) as a permanent storage device. The system memory can be a read-and-write memory device or a volatile read-and-write memory, such as dynamic random access memory. The system memory can store some or all of the instructions and data that the processor needs at runtime.

Storage subsystem 1110 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 1110 can include removable storage media that can be readable and/or writeable; examples of such media include compact disc (CD), read-only digital versatile disc (e.g., DVD-ROM, dual-layer DVD-ROM), read-only and recordable Blue-Ray® disks, ultra density optical disks, flash memory cards (e.g., SD cards, mini-SD cards, micro-SD cards, etc.), magnetic “floppy” disks, and so on. The computer readable storage media do not include carrier waves and transitory electronic signals passing wirelessly or over wired connections.

In some embodiments, storage subsystem 1110 can store one or more software programs to be executed by processing unit(s) 1105, such as a user interface 1115. As mentioned, “software” can refer to sequences of instructions that, when executed by processing unit(s) 1105 cause computer system 1100 to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 1110, processing unit(s) 1105 can retrieve program instructions to execute and data to process in order to execute various operations described herein.

A user interface can be provided by one or more user input devices 1120, display device 1125, and/or and one or more other user output devices (not shown). Input devices 1120 can include any device via which a user can provide signals to computing system 1100; computing system 1100 can interpret the signals as indicative of particular user requests or information. In various embodiments, input devices 1120 can include any or all of a keyboard touch pad, touch screen, mouse or other pointing device, scroll wheel, click wheel, dial, button, switch, keypad, microphone, and so on.

Output devices 1125 can display images generated by electronic device 1100. Output devices 1125 can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like), indicator lights, speakers, tactile “display” devices, headphone jacks, printers, and so on. Some embodiments can include a device such as a touchscreen that function as both input and output device.

In some embodiments, output device 1125 can provide a graphical user interface, in which visible image elements in certain areas of output device 1125 are defined as active elements or control elements that the user selects using user input devices 1120. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular array in output device 1125. Other user interfaces can also be implemented.

Network interface 1135 can provide voice and/or data communication capability for electronic device 1100. In some embodiments, network interface 1135 can include radio frequency (RF) transceiver components for accessing wireless voice and/or data networks (e.g., using cellular telephone technology, advanced data network technology such as 3G, 4G or EDGE, Bluetooth, WiFi (IEEE 802.11 family standards, or other mobile communication technologies, or any combination thereof), GPS receiver components, and/or other components. In some embodiments, network interface 1135 can provide wired network connectivity (e.g., Ethernet) in addition to or instead of a wireless interface. Network interface 1135 can be implemented using a combination of hardware (e.g., antennas, modulators/demodulators, encoders/decoders, and other analog and/or digital signal processing circuits) and software components.

Bus 1140 can include various system, peripheral, and chipset buses that communicatively connect the numerous internal devices of electronic device 1100. For example, bus 1140 can communicatively couple processing unit(s) 1105 with storage subsystem 1110. Bus 1140 also connects to input devices 1120 and display 1125. Bus 1140 also couples electronic device 1100 to a network through network interface 1135. In this manner, electronic device 1100 can be a part of a network of multiple computer systems (e.g., a local area network (LAN), a wide area network (WAN), an Intranet, or a network of networks, such as the Internet. Any or all components of electronic device 1100 can be used in conjunction with the invention.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

It will be appreciated that computer system 1100 is illustrative and that variations and modifications are possible. Computer system 1100 can have other capabilities not specifically described here (e.g., mobile phone, global positioning system (GPS), power management, one or more cameras, various connection ports for connecting external devices or accessories, etc.). Further, while computer system 1100 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

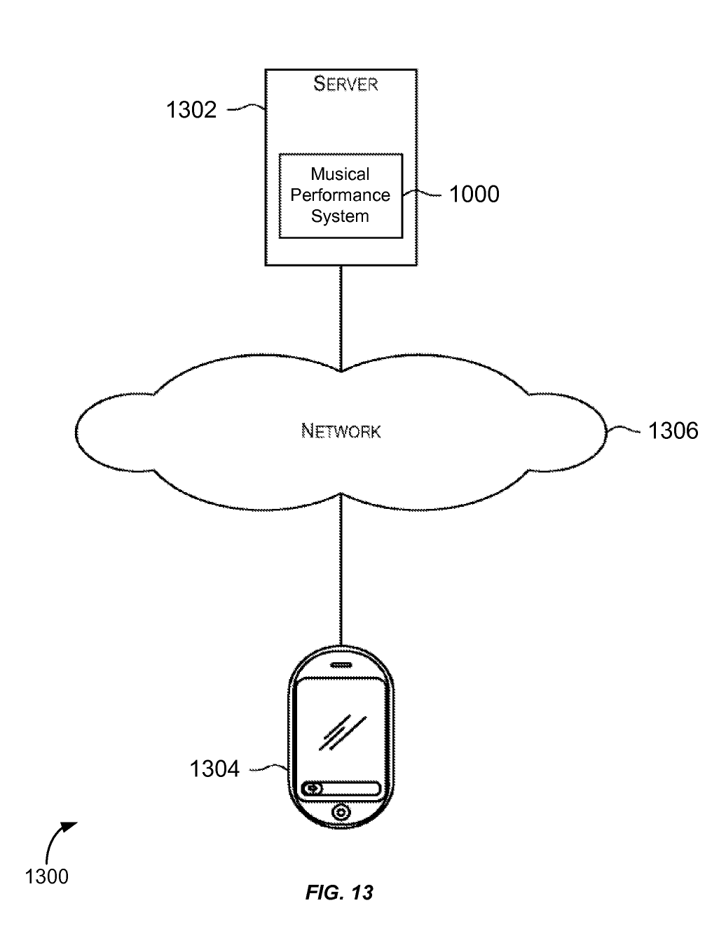

System 1000 depicted in FIG. 10 may be provided in various configurations. In some embodiments, system 1000 may be configured as a distributed system where one or more components of system 1000 are distributed across one or more networks in the cloud. FIG. 13 depicts a simplified diagram of a distributed system 1300 for providing a system and method for music collaboration according to some embodiments. In the embodiment depicted in FIG. 13, musical performance system 1000 is provided on a server 1302 that is communicatively coupled with a remote client device 1304 via network 1306.

Network 1306 may include one or more communication networks, which could be the Internet, a local area network (LAN), a wide area network (WAN), a wireless or wired network, an Intranet, a private network, a public network, a switched network, or any other suitable communication network. Network 1306 may include many interconnected systems and communication links including but not restricted to hardwire links, optical links, satellite or other wireless communications links, wave propagation links, or any other ways for communication of information. Various communication protocols may be used to facilitate communication of information via network 1306, including but not restricted to TCP/IP, HTTP protocols, extensible markup language (XML), wireless application protocol (WAP), protocols under development by industry standard organizations, vendor-specific protocols, customized protocols, and others.

In the configuration depicted in FIG. 13, the musical performance system 1000 may be displayed by client device 1304. A user of client device 1304 may initiate a jam session (i.e., musical collaboration) with other electronic devices via network 1306.

In the configuration depicted in FIG. 13, musical performance system 1000 is remotely located from client device 1304. In some embodiments, server 1302 may host a jam session for multiple clients. The multiple clients may be served concurrently or in some serialized manner. In some embodiments, the services provided by server 1302 may be offered as web-based or cloud services or under a Software as a Service (SaaS) model.

It should be appreciated that various different distributed system configurations are possible, which may be different from distributed system 1300 depicted in FIG. 13. The embodiment shown in FIG. 13 is thus only one example of a system or method of musical collaboration and is not intended to be limiting.

While the invention has been described with respect to specific embodiments, one skilled in the art will recognize that numerous modifications are possible. Thus, although the invention has been described with respect to specific embodiments, it will be appreciated that the invention is intended to cover all modifications and equivalents within the scope of the following claims.

The above disclosure provides examples and aspects relating to various embodiments within the scope of claims, appended hereto or later added in accordance with applicable law. However, these examples are not limiting as to how any disclosed aspect may be implemented,

All the features disclosed in this specification (including any accompanying claims, abstract, and drawings) can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, sixth paragraph. In particular, the use of “step of” in the claims herein is not intended to invoke the provisions of 35 U.S.C. §112, sixth paragraph.

What is claimed is:

1. A method of creating a music collaboration session between a plurality of electronic devices, the method comprising:
creating, on a first electronic device, a host session on a digital music software platform, the host session configured to receive data to create and record a host song, the host song including one or more song architecture parameters;
receiving, by the first electronic device, a request from a second electronic device to join the host session;
transmitting the one or more song architecture parameters from the first electronic device to the second electronic device to align the architecture parameters of a client song to the one or more architecture parameters of the host song; and
adding, by the first electronic device, the second electronic device to the host session, wherein the host session is configured to control recording and playback operations of the host song and the aligned client song.

2. The method of claim 1 wherein the receiving and transmitting are performed over a wireless communications link including one of a WiFi or Bluetooth communication link.

3. The method of claim 1 further comprising:
requesting a portion of a client song from the second electronic device;
receiving the portion of the client song from the second electronic device;
incorporating elements of the portion of the client song into the host song; and
ending the host session.

4. The method of claim 3 wherein requesting the client song from the second electronic device is initiated manually by a user operating the first electronic device or automatically by the first electronic device.

5. The method of claim 1 wherein the one or more architecture parameters of each of the host and client songs include primary parameters and secondary parameters, wherein the primary parameters include song section data and time signature data.

6. The method of claim 5 wherein the secondary parameters include tempo data, key signature data, custom chord data, master effects preset selection data, count-in data, and fade out data.

7. The method of claim 1 further comprising:
receiving, by the first electronic device, a request from a third electronic device to join the host session;
transmitting the one or more song architecture parameters from the first electronic device to the third electronic device to align the architecture parameters of a second client song to the architecture parameters of the host song; and
adding, by the first electronic device, the third electronic device to the host session, wherein the host session is configured to control recording and playback operations of the host song and the aligned second client song.

8. A system comprising:
a display device;
an input device for navigating the display; and
a processor coupled to the display and the input device, the processor further adapted to:
create, on a first electronic device, a host session on a digital music software platform, the host session configured to receive data to create and record a host song, the host song including one or more song architecture parameters;
receive, by the first electronic device, a request from a second electronic device to join the host session;
transmit the one or more song architecture parameters from the first electronic device to the second electronic device to align the architecture parameters of a client song to the one or more architecture parameters of the host song; and
add, by the first electronic device, the second electronic device to the host session, wherein the host session is configured to control recording and playback operations of the host song and the aligned client song.

9. The system of claim 8 wherein the receiving and transmitting are performed over a wireless communications link including one of a WiFi or Bluetooth communication link.

10. The system of claim 8 wherein the processor is further adapted to:
request a portion of a client song from the second electronic device;
receive the portion of the client song from the second electronic device;
incorporate elements of the portion of the client song into the host song; and
end the host session.

11. The system of claim 10 wherein requesting the client song from the second electronic device is initiated manually by a user operating the first electronic device or automatically by the first electronic device.

12. The system of claim 8 wherein the one or more architecture parameters of each of the host and client songs include primary parameters and secondary parameters, wherein the primary parameters include song section data and time signature data.

13. The system of claim 12 wherein the secondary parameters include tempo data, key signature data, custom chord data, master effects preset selection data, count-in data, and fade out data.

14. The system of claim 8 wherein the processor is further adapted to:
receive, by the first electronic device, a request from a third electronic device to join the host session;
transmit the one or more song architecture parameters from the first electronic device to the third electronic device to align the architecture parameters of a second client song to the architecture parameters of the host song; and
add, by the first electronic device, the third electronic device to the host session, wherein the host session is configured to control recording and playback operations of the host song and the aligned second client song.

15. A computer program product for creating a music collaboration session between a plurality of electronic devices, the computer program product comprising:
a computer-readable medium;
a processing module residing on the computer-readable medium and operative to:
create, on a first electronic device, a host session on a digital music software platform, the host session configured to receive data to create and record a host song, the host song including one or more song architecture parameters;
receive, by the first electronic device, a request from a second electronic device to join the host session;
transmit the one or more song architecture parameters from the first electronic device to the second electronic device to align the architecture parameters of a client song to the one or more architecture parameters of the host song; and
add, by the first electronic device, the second electronic device to the host session, wherein the host session is configured to control recording and playback operations of the host song and the aligned client song.

16. The computer program product of claim 15 wherein the receiving and transmitting are performed over a wireless communications link including one of a WiFi or Bluetooth communication link.

17. The computer program product of claim 15 wherein the processor is further adapted to:
request a portion of a client song from the second electronic device;
receive the portion of the client song from the second electronic device;
incorporate elements of the portion of the client song into the host song; and
end the host session.

18. The computer program product of claim 17 wherein requesting the client song from the second electronic device is initiated manually by a user operating the first electronic device or automatically by the first electronic device.

19. The computer program product of claim 15 wherein the one or more architecture parameters of each of the host and client songs include primary parameters and secondary parameters, wherein the primary parameters include song section data and time signature data.

20. The computer program product of claim 19 wherein the secondary parameters include tempo data, key signature data, custom chord data, master effects preset selection data, count-in data, and fade out data.
